(19) United States
(12) Patent Application Publication
(10) Pub. No.: US 2004/0163625 A1
(43) Pub. Date: Aug. 26, 2004

(54) Fuel injector

(76) Inventors: Kai Lehtonen, Vaasa (FI); David C. Jay, Vahakyro (FI)

Correspondence Address: SMITH-HILL AND BEDELL, 12670 N W BARNES ROAD, SUITE 104, PORTLAND, OR, 97229

(21) Appl. No.: 10/476,678

(22) PCT Filed: Apr. 18, 2002
(86) PCT No.: PCT/FI02/00323

(30) Foreign Application Priority Data
May 14, 2001 (FR) 01/06349

(51) Int. Cl. F02M 1/00

(52) U.S. Cl. 123/445

(57) ABSTRACT

A fuel injection arrangement, which comprises a fuel source and a fuel nozzle connected thereto, including a fuel chamber and a needle valve arrangement in connection with the fuel chamber for controlling the fuel injection and an arrangement for bringing about a force effect on the valve of the needle valve arrangement in the closing direction thereof; a fuel control arrangement by means of the different switching positions of which, the fuel flow connection is connectable between the fuel source and the fuel chamber of the fuel nozzle as well as between the fuel source and the arrangement for bringing about a force effect, in which the fuel control arrangement comprises a mechanical force unit for changing its switching positions.

The present invention relates to a fuel injector for injection of fuel at high pressure into a cylinder in an internal combustion engine, comprising a first S pressure chamber located at a valve seat, a main spindle which, in a closed position, abuts the valve seat and cuts the fuel off from access from the first pressure chamber to atomizer nozzles and, in an open position, is displaced away from the valve seat and permits injection of fuel, a second pressure chamber located separately from the first pressure chamber and containing a first opening area on the main spindle, a third pressure chamber containing a closing area on the main spindle, and a pilot spool that, via a flow passage, can connect a high-pressure port with the second pressure chamber.

Such a fuel injector is known from DE 30 09 750 A1, in which the pilot spool can only control hydraulic fluid access to an opening area on the main spindle, and in which a further slide valve constitutes a safety valve which cuts the fuel off from access to the first pressure chamber. This fuel injector has a relatively complex design. The main spindle is influenced by a closing pressure which is controlled quite independently of both the pilot spool and the slide valve.

JP-A 59-188068 describes an electronically controlled servo-valve which can displace the pilot spool by pressurizing a chamber, so as to cut off the connection between the fuel supply and the first pressure chamber at the valve seat, resulting in closure of the fuel injector. When the fuel injector is to open, the servo-valve is switched to displace the pilot spool to the opposite position where the fuel pressure has free access to the first pressure chamber and can influence the main spindle with a considerable opening force. At the same time, the servo-valve applies control oil to the second pressure chamber at a pressure that influences the main spindle in the opening direction, while the main spindle is influenced in the closing direction by the fuel pressure continuously applied to the third pressure chamber. It is a disadvantage that the fuel injector has a complex design, and that the fuel pressure influences the main spindle continuously in the closing direction. It is also a disadvantage that the fuel pressure in the first pressure chamber has a primary influence on the opening movement of the main spindle, as the pressure drop in this chamber, at the opening of the connection between the chamber and the atomizer nozzles and initiation of the fuel injection, may result in a return movement of the main spindle towards the valve seat, where it may restrict or interrupt the fuel supply to the atomizer.

JP-A 59-190468 describes a fuel injector actuated by a separate control valve with a valve spindle that can connect a third pressure chamber having a closing area with either a drain or with the pressure source of the fuel. The fuel pressure is continuously applied to a first pressure chamber comprising the opening area of the fuel injector.

A fuel injector described in EP-A 748933 is opened by the fuel pressure in a first pressure chamber and in a second pressure chamber rising to exceed the opening pressure and is closed by means of a compression spring. Via a passage with a slide valve, a secondary opening area in the second pressure chamber communicates with the fuel passage. When the fuel pressure exceeds a predetermined value, the passage is closed, which means that the slide valve is inactive when the fuel injector is to close.

It is an object of the present invention to provide a fuel injector which opens and closes accurately, whether the fuel injector is to inject a large or a small volume of fuel.

In view of this, the fuel injector is characterized in that in a first position the pilot spool connects the high-pressure port with the second pressure chamber and a low-pressure port with the third pressure chamber, whereby the main spindle is in its open position, and that in a second position the pilot spool connects the low-pressure port with the flow passage to the second pressure chamber and the high-pressure port with the third pressure chamber, whereby the main spindle is in its closed position.

The pilot spool does not, like the main spindle, have to cut off the fuel from access to the atomizer nozzles when the fuel injector is closed, and the pilot spool can therefore have an advantageously small mass making it suitable for rapid application and interruption of pressure. Passing the high pressure to the second pressure chamber while ensuring pressure relief of the third chamber ensures that the opening of the injector takes place substantially independently of the current fuel pressure in the first pressure chamber. The injector closure also takes place rapidly and accurately by the pilot spool passing the high pressure to the third chamber with the closing area while providing pressure relief to the second chamber. It is an advantage that the pressure is relieved both at the opening and the closing of the injector so that the active high pressure does not have to overcome a counter-acting residual pressure. This allows the masses of the movable parts to be reduced because the size of the active areas can be reduced, and this has a positive effect on the adjustment speed of the fuel injector.

The pilot spool is preferably influenced by a primary compression spring in a direction towards its second position. The compression spring is mechanical and independent of the external control systems supplying high pressure and control signals, and it therefore ensures that the pilot spool is in its second position in which the fuel injector is influenced to a closed position if a failure occurs in the external systems.

In a preferred embodiment the pilot spool is hydraulically influenced for moving from its second to its first position at a predetermined opening pressure, and the main spindle is displaceable from its closed to its open position when the first opening area of the main spindle is influenced by a predetermined actuation pressure lower than the opening pressure. The hydraulic actuation of the pilot spool is extremely reliable and accurate. As the actuation pressure for displacement of the main spindle is lower than the opening pressure for moving the pilot spool to its first position, in which the pilot spool passes the pressure on to the second chamber with the first opening area, the main spindle is influenced from the start of its opening movement by a force larger than required for moving the main spindle to the open position. This excess force depends on the predetermined pressures, and choosing a suitably large difference, such as an actuation pressure at least 50 bar lower than the opening pressure, ensures that the main spindle is moved in a well-defined manner in a single movement to the fully open position without the possibility of reciprocating a couple of times between the open and the closed positions. The fuel in the first chamber thus gains full and constant access to the atomizer during the entire period when the fuel injector is to be open, and slow initiation of the atomization with a risk of throttling across the valve seat as a consequence of an injector only partially open is avoided. It is also possible to choose a somewhat smaller difference, such as an actuation pressure from 10 to 50 bar lower than the opening pressure if special injection sequences with intermittent fuel injection are desired.

It is possible to use a control oil different from the fuel for actuating the pilot spool and influencing the main spindle in the second and the third pressure chambers. This may be of interest, for example, in the cases where it is desired to keep the pilot spool in a cleaner environment than the one obtainable with heavy fuel oil, or where the fuel is continuously supplied to the first pressure chamber from a high-pressure accumulator. Alternatively, the fuel can be used for actuation of the pilot spool, and the fuel passage leading to the first pressure chamber can then suitably communicate with the high-pressure port. This provides a simple design of the injector.

When fuel is used for actuation of the pilot spool, a throttle means can advantageously be provided in the connection between the fuel passage and the high-pressure port. When the main spindle opens, a transitory pressure drop may occur in the fuel passage, and the throttle means dampens the propagation of the pressure drop to the pilot spool and the second pressure chamber.

It is possible to design the fuel injector completely without mechanical springs, but as mentioned above it is preferred for safety reasons that the pilot spool is pre-loaded by a primary compression spring ensuring a closed injector in case of failure of external systems. To further improve safety, the pilot spool may be influenced in a direction towards its second position by a primary compression spring with a primary spring force (PSF), and the pilot spool may have a piston surface with a piston area (PA) that can be influenced by hydraulic pressure, and the main spindle is influenced in a direction towards the valve seat by a secondary compression spring with a secondary spring force (SSF), the primary spring force being larger than the secondary spring force multiplied by the ratio between the piston area and the opening area (PSF>SSF×(PA/OA)). The secondary compression spring can keep the main spindle in abutment against the valve seat while the maximum combustion pressure influences the part of the end surface of the main spindle that is exposed to the pressure in the atomizer bore. This further means that the active closing pressure in the third pressure chamber need not be maintained during the entire relatively large part of an engine cycle when the fuel injector merely has to be kept closed, provided that the pressure in the third chamber is present when and immediately after the main spindle moves from its open position into abutment against the valve seat so that this move takes place in a rapid and well-defined manner.

As an alternative to a hydraulically actuated pilot spool, the pilot spool in a further embodiment may be connected to the movable part of an electromagnetic drive, such as a solenoid, whereby the pilot spool can be actuated electronically by control signals supplied from an electronic control unit.

Several fuel injectors may be arranged on a single cylinder, and the fuel injector is typically passed down through a cylinder cover or alternatively through the side wall of a cylinder, that is, passed through a highly loaded cylinder member, and it is therefore advantageous to design the fuel injector with an injector housing having the smallest diameter possible. Preferably, therefore, the longitudinal axis of the pilot spool extends in parallel, preferably coaxially, with the longitudinal axis of the main spindle so that the pilot spool takes up a minimum amount of space in the transverse direction.

It is an advantage of the fuel injector of the invention that in its opening and closing function it is substantially uninfluenced by pressure fluctuations in the fuel in the first pressure chamber. Of course, it is possible to design the main spindle with a certain opening area in the first pressure chamber, but as it is not necessary in consideration of the opening of the injector, the main spindle preferably has no such opening area, that is, in its closed position in abutment against the valve seat, the main spindle is uninfluenced in its longitudinal direction by the pressure in the first pressure chamber. This means that the main spindle is bistable, that is, that it can only set itself in either the fully open or fully closed position.

Examples of embodiments of the invention will now be described in more detail below with reference to the very schematic drawing, in which

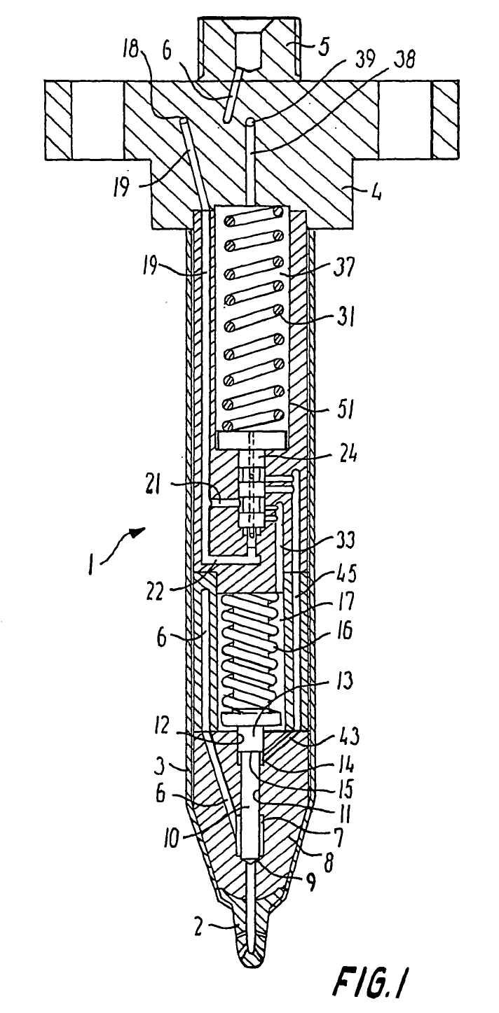

FIG. 1 is a longitudinally sectional view through a first embodiment of a fuel injector with a pilot spool according to the invention,

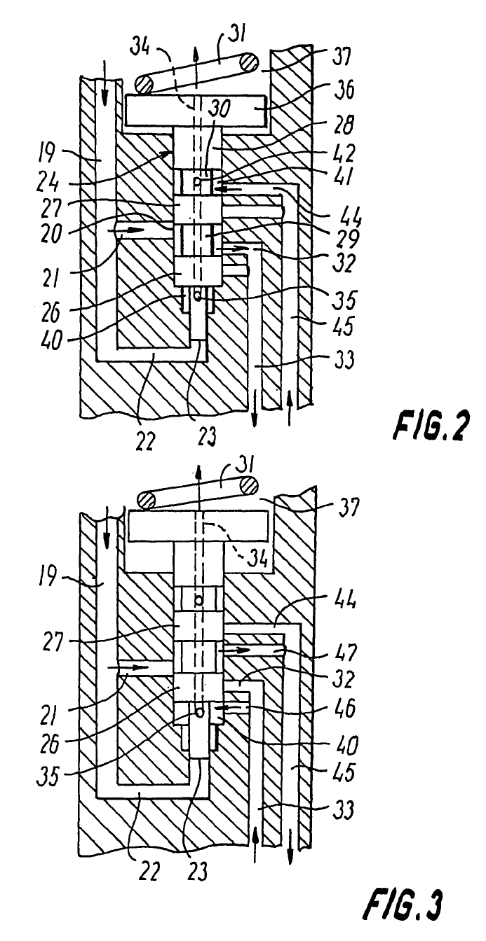

FIGS. 2 and 3 are views of enlarged segments of the area around the pilot spool of FIG. 1, and

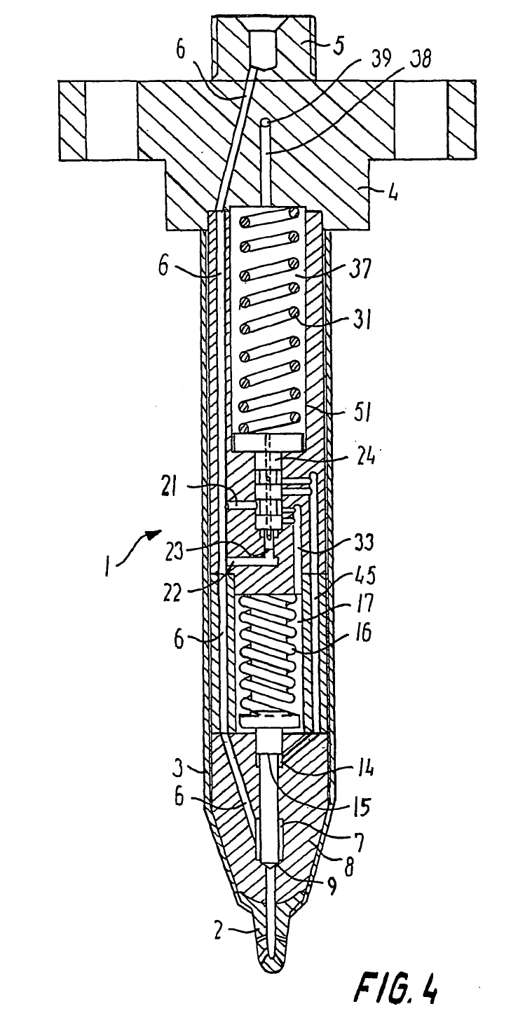

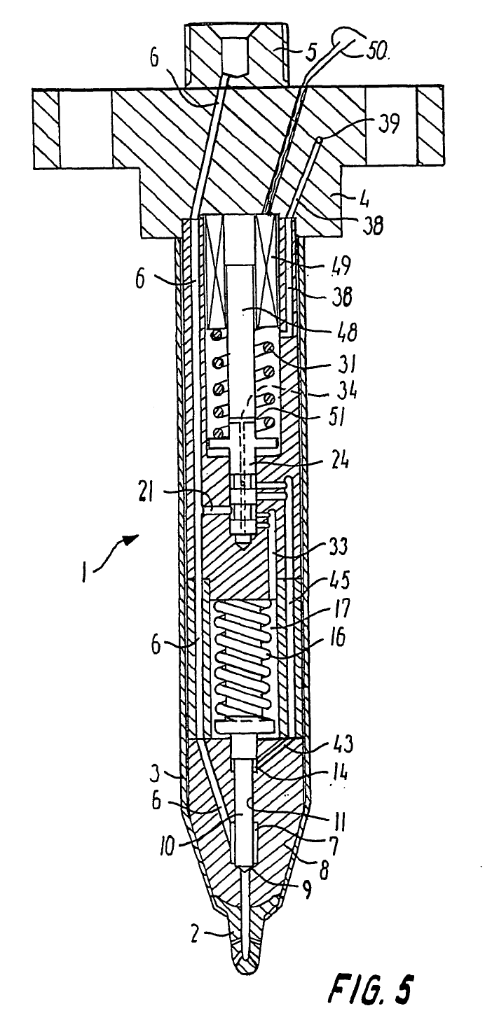

FIGS. 4 and 5 are illustrations corresponding to FIG. 1 of a second and a third embodiment.

FIG. 1 shows a fuel injector 1, which can be inserted in an associated through hole in a cylinder cover, not shown, so that the tip of an atomizer 2 projects into a combustion chamber of the associated engine cylinder. The fuel injector comprises an injector housing 3, fastened in a manner not shown in detail to a fastening piece 4, which can be bolted to the cylinder cover. A high-pressure source of fuel, such as oil or liquid gas, is connected to a threaded connection 5, and a fuel channel 6, only partially located in the section shown, connects the inlet of the threaded connection 5 with a first pressure chamber 7 in a spindle guide 8. If liquid gas is used as fuel, the fuel can alternatively be supplied from a fuel inlet extending in the cover, and in that case the fuel injector may have an oblique channel in the spindle guide 8, which channel opens out into the injector housing at the fuel inlet and leads into the first pressure chamber 7.

A valve seat 9 is formed in the spindle guide 8 at the bottom of the first pressure chamber. This valve seat is stationary, and in its bottom surface a main spindle 10 has a corresponding, movable seat surface that may sealingly abut the valve seat 9. The main spindle is mounted in the spindle guide 8 so as to be longitudinally displaceable and has a constant external diameter in the section from the abutment against the valve seat and up through a bore 11 in the spindle guide. The bore 11 has the same diameter as the largest abutment diameter of the main spindle against the valve seat. At the top of the spindle guide the main spindle passes up through a bore 12 having a larger diameter than the bore 11, and in an upper section 13 the main spindle has a larger diameter mainly corresponding to the diameter of the bore 12.

A lower section of the bore 12 constitutes a second pressure chamber 14. The upper section 13 of the main spindle is connected with the lower section with a smaller diameter through a downward, annular surface constituting a first opening area 15 (OA) on the main spindle. The size of the opening area corresponds to the difference of the cross-sectional areas of the upper section 13 of the main spindle and its lower section in the bore 11. The pressure in the second pressure chamber 14 impacts on the first opening area and influences the main spindle with an opening force directed upwards away from the valve seat 9.

At the top, the main spindle has a collar constituting a spring guide for a secondary compression spring 16 arranged around a stationary spring guide in a third pressure chamber 17. The compression spring presses the main spindle downwards towards the valve seat with a secondary spring force SSF, and the upper surface of the collar at the top of the main spindle constitutes a first closing area, whose size corresponds to the cross-sectional area of the upper section 13 of the main spindle. If it is desired that this area should be smaller, the embodiment may, for example, be modified by the collar of the main spindle being supplied with an upright central journal passing in a pressure-sealing, but axially movable manner up into a central bore in the stationary spring guide for the compression spring 16, which bore is drained to have a low pressure in the area above the journal. Thus, the closing area is reduced by the cross-sectional area of the upright journal. The pressure in the third pressure chamber 17 impacts on the first closing area and influences the main spindle with a closing force directed downwards towards the valve seat 9.

A transverse connection, not shown, for control oil is connected to a control oil source, and via a transverse bore 18 it communicates with a supply channel 19 which is connected with a high-pressure port 20 via a channel 21 and, via a flow passage 22, passes control oil to a piston surface 23 at the end of a cylindrical journal of a pilot spool 24, see FIGS. 2 and 3. The piston surface has the area PA. The pilot spool is arranged so as to be longitudinally displaceable in a bore 25 extending in parallel and coaxially with the bore 11. The pilot spool has three control sections 26, 27 and 28, which fit sealingly in the bore and are interconnected by intermediate sections 29 and 30 with a reduced diameter to provide control edges at the ends of the three control sections.

A primary compression spring 31 presses the pilot spool downwards so that the lower control section 26 abuts a projection at the bottom of the bore 25. This inactive position is called the second position of the pilot spool, and the intermediate section 29 is here located opposite to a first transverse channel 32 communicating with the third pressure chamber 17 via a longitudinal channel 33. As the intermediate section 29 is continuously located opposite to the high-pressure port 20, the current control oil pressure in the supply channel 19 is transferred to the third pressure chamber via the pilot spool 24 when in its said second position.

A central longitudinal bore 34 in the pilot spool extends from a transverse hole 35 below the control section 26 and up to the upper surface of a spring guide 36 on the pilot spool, where the bore 34 opens out in a low-pressure port 51 in a cavity 37 which, via a drain passage 38, 39 in the fastening piece 4, communicates with a low-pressure tank return draining off spent oil. The transverse hole 35 thus keeps a cavity 40 below the control section 26 at a continuously low pressure. A corresponding transverse hole 42 in the pilot spool crosses the longitudinal bore 34 in the intermediate section 30 and connects an annular cavity 41 between the control sections 27 and 28 with the cavity 37 so that also the cavity 41 is kept continuously at a low pressure.

In the second position of the pilot spool 24 shown in FIG. 2, the cavity 41 is located opposite to another transverse passage 44, which communicates with the second pressure chamber 14 via a flow passage with a longitudinal section 45 and an oblique section 43 so that the second pressure chamber is drained so as to have low pressure.

When the external control means make the control oil pressure in the supply channel 19 rise, the pressure in the third pressure chamber rises so that the main spindle is pressed more firmly against the valve seat while the pressure on the piston surface 23 rises so that the pilot spool is influenced with a growing upward force acting opposite to the force from the primary compression spring. When the spring force is overcome, the pilot spool is displaced upwards and assumes a first position illustrated in FIG. 3.

In this position, the control section 26 is displaced upwards to cut off the first transverse channel so that the communication between the high-pressure port and the third pressure chamber is interrupted, while the cavity 40 communicates with a third transverse channel 46, which connects the third pressure chamber to the low pressure in the cavity 40 via the channel 33. Furthermore, the middle control section 27 is displaced upwards to cut off the other transverse passage 44, whereby the low-pressure connection to the second pressure chamber is interrupted, while the high-pressure port 20 communicates with a fourth transverse channel 47, which communicates with the second pressure chamber including the opening area of the main spindle via the flow passage 43, 45. The main spindle is therefore suddenly influenced with an upward force moving the main spindle to its fully open position, and the injection of fuel starts with full access to the atomizer nozzles in the atomizer 2.

When it is desired to interrupt the injection, the external control means reduce the control oil pressure in the supply channel 19 to a suitably low level so that the primary compression spring displaces the pilot spool to the second position shown in FIG. 2, whereby, as explained above, the main spindle immediately sets itself to a closed condition in abutment against the valve seat 9. It is possible for the external control means to let the control oil pressure lapse completely between the injection periods because in the embodiment shown the main spindle is influenced by the compression spring 16, but preferably the control means alternate between two predetermined control oil pressures, the low pressure being sufficiently high so that it can itself keep the main spindle in the closed position by impact on the first closing area in the third pressure chamber, and sufficiently low so that it only influences the piston surface 23 with a force lower than the force from the spring 31, and the high pressure being sufficiently high so that it can overcome the force from the spring 31 and the force from the spring 16.

In the following description of other embodiments, the same reference numerals as above will be applied for details having the same function, and only the deviations in relation to the first embodiment will be explained in detail.

The second embodiment shown in FIG. 4 deviates in that the fuel channel 6 is connected with both the channel 21 to the high-pressure port 20 and with the flow passage 22 to the piston surface 23 of the pilot spool, and in that there is no control oil supply. The fuel can be supplied from an accumulator with high-pressure fuel when an external control valve opens for supply therefrom, or it may be supplied from a fuel pump supplying oil when an injection is to be made. This pump may, for example, be cam-disc-driven and controlled by a camshaft or hydraulically driven and controlled by an electronic control unit. When the fuel pressure exceeds the opening pressure influencing the piston surface 23 with a force larger than the primary spring force PSF from the primary compression spring 31, the pilot spool is moved to its first position, whereby the main spindle is opened. When the fuel pressure subsequently drops below the opening pressure, the pilot spool is displaced to its second position, whereby the main spindle is closed. The fuel injector thus has the same opening and closing pressures.

The third embodiment shown in FIG. 5 deviates in that the pilot spool is not hydraulically controlled. The flow passage 22 and the cylindrical journal with the piston surface are omitted, and instead the pilot spool is provided with an upright ferro-magnetic member 48 which passes into an electric coil 49, which can be magnetized by current supplied through wires 50 and thus pull the member 48 and the pilot spool up into the first position by overcoming the force from the spring 31. When the current is interrupted, the spring presses the pilot spool back to the second position. Preferably, the channel 21 to the high-pressure port is connected to the fuel channel 6, and if it is desired that the pilot spool can only be actuated to its first position when the fuel pressure is sufficiently high to influence the first opening area OA with a force moving the main spindle to an open position, then the control unit that actuates the coil 49 may be connected with a pressure sensor for measuring the current fuel pressure in the high-pressure source of fuel and be adapted to only being able to actuate the coil 49 when the fuel pressure exceeds the opening pressure. This is of interest particularly for a high-pressure source which only periodically produces a high fuel pressure. Alternatively, the high-pressure source may be an accumulator with a suitably high pressure, or the channel 21 may be connected to a separate control oil system kept continuously at a pressure above the opening pressure. In the embodiment shown in FIG. 5 the pilot spool is not influenced in its longitudinal direction by the pressure at the high-pressure port, and the spring 31 is therefore a pure return spring returning the pilot spool to the second position when the coil 49 is not energized.

Details of the different embodiments can be combined into new embodiments; the third embodiment can, for example, be designed with a flow passage 22 and a cylindrical journal like the second embodiment to allow hydraulic operation of the fuel injector in case of failure of the electrical driving system. It is also possible to design the main spindle with an extension projecting down into the atomizer bore for carrying secondary closing means or other modifications. As mentioned above it is possible to omit one or both compression springs, as closing areas, opening areas and the area of the piston surf ace can be adapted accordingly.

The engine with the fuel injector may, for example, be a large two-stroke crosshead engine used as a stationary power-producing engine or as the propulsion engine of a ship. The engine may also be a four-stroke engine with a high output. Whether the engine is a two-stroke or four-stroke engine, it has a large bore, such as a cylinder bore exceeding 200 mm, preferably exceeding 240 mm. The engine can be made in a medium or large size with outputs from, for example, 2000 kW to 120,000 kW.

1. A fuel injector (1) for injection of fuel at high pressure into a cylinder in an internal combustion engine, comprising a first pressure chamber (7) located at a valve seat (9), a main spindle (10) which, in a closed position, abuts the valve seat and cuts the fuel off from access from the first pressure chamber to atomizer nozzles and, in an open position, is displaced away from the valve seat and permits injection of fuel, a second pressure chamber (14) located separately from the first pressure chamber and containing a first opening area (OA) (15) on the main spindle, a third pressure chamber (17) containing a closing area on the main spindle (10), and a pilot spool (24) that, via a flow passage, can connect a high-pressure port with the second pressure chamber, characterized in that in a first position the pilot spool connects the high-pressure port (20) with the second pressure chamber (14) and a low-pressure port (51) with the third pressure chamber (17), whereby the main spindle is in its open position, and that in a second position the pilot spool (24) connects the low-pressure port with the flow passage to the second pressure chamber (14) and the high-pressure port with the third pressure chamber (17), whereby the main spindle is in its closed position.

2. A fuel injector according to claim 1, characterized in that the pilot spool (24) is influenced by a primary compression spring (31) in a direction towards its second position.

3. A fuel injector according to claim 2, characterized in that the pilot spool (24) is hydraulically influenced for moving from its second to its first position at a predetermined opening pressure, and that the main spindle (10) is displaceable from its closed to its open position when the first opening area (15) of the main spindle is influenced by a predetermined actuation pressure lower than said opening pressure.

4. A fuel injector according to claim 3, characterized in that the actuation pressure is at least 50 bar lower than said opening pressure.

5. A fuel injector according to claim 3, characterized in that the actuation pressure is from 10 to 50 bar lower than the opening pressure.

6. A fuel injector according to any one of claims 1 to 5, characterized in that a fuel passage (6) leading to the first pressure chamber (7) communicates with the high-pressure port (20).

7. A fuel injector according to any one of claims 1 to 6, characterized in that a throttle means is provided in the connection between the fuel passage and the high-pressure port (20).

8. A fuel injector according to any one of claims 3 to 7, characterized in that the pilot spool (24) is influenced in a direction towards its second position by a primary compression spring (31) with a primary spring force (PSF), that the pilot spool has a piston surface (23) with a piston area (PA) that can be influenced by a hydraulic pressure, that the main spindle is influenced in a direction towards the valve seat by a secondary compression spring (16) with a secondary spring force (SSF), and that the primary spring force is larger than the secondary spring force multiplied by the ratio between the piston area and the opening area (PSF >SSF×(PA/OA) ) .

9. A fuel injector according to any one of claims 1 to 8, characterized in that the pilot spool (24) is connected to the movable part of an electromagnetic drive, such as a solenoid.

10. A fuel injector according to any one of claims 1 to 9, characterized in that the longitudinal axis of the pilot spool (24) extends in parallel, preferably coaxially with the longitudinal axis of the main spindle (10).

11. A fuel injector according to any one of claims 1 to 10, characterized in that in its closed position in abutment against the valve seat the main spindle (10) is uninfluenced in its longitudinal direction by the pressure in the first pressure chamber (7).
